(19) United States
(12) Patent Application Publication
(10) Pub. No.: US 2008/0229618 A1
(43) Pub. Date: Sep. 25, 2008

(54) Animal paw cover

(76) Inventor: Michelle T. McKay-Leffler, Basking Ridge, NJ (US)

Correspondence Address: Klaus P. Stoffel;Wolff & Samson, One Boland Drive, West Orange, NJ, 07052, US

(21) Appl. No.: 11/725,251

(22) Filed: Mar. 19, 2007

(51) Int. Cl. A01K 13/00

(52) U.S. Cl. 36/111

(57) ABSTRACT

An animal paw cover having a side surface, a bottom surface and an opening. An elastic band is provided along the circumference of the opening. The animal paw cover is substantially sack-shaped. The bottom surface of the paw cover is sized to have an area substantially equal to an area of an underside of a paw of an animal intended to wear this paw cover, and a height of the side surface does not substantially exceed a height of the animal's paw. Further, the elastic band constricts the opening to a size substantially smaller than the animal's paw.

### FIELD OF THE INVENTION

The present invention relates to animal paw covers protecting soles of animal paws.

### BACKGROUND OF THE INVENTION

There is a great need for a disposable protective covering for animal paws protecting the paws from wetness, dampness, dirt, chemicals, scratches, parasites, thorns, burrs, and the like. The unfilled need for an inexpensive, convenient, and sanitary, disposable covering is well known especially to dog owners. Not only is there a need for a covering which will keep dirt, mud and moisture off the paws of an animal to eliminate soiling of household floors, rugs and furniture when the animal is brought indoors but, particularly in urban areas, to also provide critical protection for the soles of animals' paws from salt and other chemicals used on city streets in the winter.

Recognizing the above problem, several solutions were presented in the art. For example, U.S. Pat. No. 6,122,901 discloses a disposable adhesive bandage for an animal foot. The bandage includes a center portion, which has a perimeter and multiple attachment tabs extending outwardly from this perimeter. The tabs are configured to be bonded to the side of the animal's foot to retain the center portion of the bandage adjacent the bottom of the animal's foot. While easy to use, the above covering creates a discomfort for an animal when the adhesive bandage has to be removed from the animal's paw.

U.S. Pat. No. 3,762,073 (“the ′073 patent”) discloses a disposable protective legging having an upper leg portion, an intermediate leg portion, and a paw portion. The legging is fabricated from two flexible sheets of heat sealable thermoplastic material which are cut to generally conform to the contours of the animal's legs. One sheet includes the back of the legging and the bottom part of the paw section. The second sheet includes the front of the legging and the top of the paw section. The two sheets of plastic are heat sealed together along the side and bottom margins, the top remaining open. The bottom of the foot portion of the legging is provided with an anti-friction sole thread which extends up the sides and front of the paw section to prevent wear and to provide additional protection for the pad and toes of the animal. The legging may be secured to the leg of the animal by the band and loop arrangement or by two pairs of adhesive strips.

Although the leggings of the ′073 patent provide good protection for animals paws and legs, they are expensive and difficult to manufacture.

Accordingly, there is a need in the art for an animal paw covering providing adequate protection for animal paws, while being easy and inexpensive to manufacture and use.

### SUMMARY OF THE INVENTION

In one of its aspects, the present invention provides an animal paw cover having a side surface, a bottom surface and an opening. An elastic band is provided along the circumference of the opening. The animal paw cover is made of a single circular piece of material without any seams so that the finished cover is substantially sack-shaped. The bottom surface of the paw cover is sized to have an area substantially equal to an area of an underside of a paw of an animal intended to wear this paw cover, and a height of the side surface does not substantially exceed a height of the animal's paw. Further, the elastic band constricts the opening to a size substantially smaller than the animal's paw. Additionally, a substantially round protective cover is attached to the circular piece of material so as to be substantially on the bottom surface of the paw cover. The protective cover can be centered on the circular piece of material or, preferably is off center.

In another aspect, the present invention provides an animal paw cover comprising a sack. The sack includes a side surface having a height and an opening having an elastic band secured thereto. The elastic band constricts the opening to a size substantially smaller than a paw of an animal intended to wear the paw cover. The height of the side surface does not substantially exceed a height of the animal's paw such that, when the animal paw cover is placed onto the animal's paw, the entire animal paw cover is positioned substantially around a paw's perimeter leaving a top portion of the paw exposed.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 shows a side view of the animal paw cover, in accordance with the preferred embodiment of the invention.

FIG. 1a shows a cross-sectional view of the invention shown in FIG. 1.

FIG. 2 shows a top view of the animal paw cover shown in FIG. 1.

FIG. 3 shows a bottom view of the animal paw cover, in accordance with the preferred embodiment of the invention.

FIG. 4 shows a bottom schematic view of an animal paw wearing the paw cover.

FIG. 5 shows a side schematic view of an animal paw wearing the paw cover.

FIG. 6 shows a front schematic view of an animal paw wearing the paw cover.

### DETAILED DESCRIPTION OF THE INVENTION

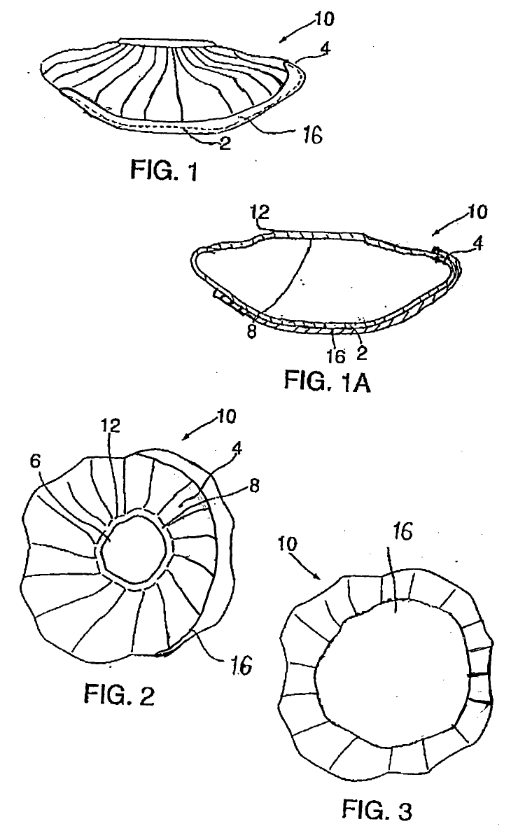

As shown in FIGS. 1-3, in accordance with the present invention, an animal paw cover 10 is provided. In accordance with the preferred embodiment, paw cover 10 is substantially sack-shaped and includes an outer bottom surface 2, a side surface 4 and an opening 6. The sack-shape is formed from a single circular piece of material without seams. Outer bottom surface 2 of paw cover 10 is preferably sized to have an area substantially equal to an area of the underside of a paw of an animal intended to wear the paw cover. The height of side surface 4 preferably does not substantially exceed the height of the animal's paw. Opening 6 is surrounded by an elastic band 8 which constricts the opening to a size substantially smaller than a paw of an animal intended to wear the paw cover. In its expanded state, however, opening 6 is large enough for the animal's paw to be placed in the paw cover. Channel 12 may be provided along the circumference of opening 6. Elastic band 8 may be inserted into channel 12 or simply attached to an internal surface of the paw cover along the circumference of opening 6. As shown in FIG. 1, when the paw cover is not worn by an animal, it is substantially saucer-shaped.

As shown in FIGS. 1 and 1a, a protective cover 16 is added to the bottom of the paw cover 10. Protective cover 16 is preferably made of a vinyl material, covers the entire area of the outer bottom surface 2 and extends slightly over a frontal portion of the side surface 4 so as to protect the paw cover from being pierced by animal's nails. Protective cover 16 may be glued or sealed to the outer surface of the paw cover. The protective cover can also be made of other materials, such as polyvinylchloride (PVC) or polylatex. The protective cover 16 is preferably round and mounted off-center to the circular piece of material forming the paw cover 10. It is, however, also possible to mount the protective cover 16 centered on the circular piece of material.

The paw cover of the present invention is preferably made of a microporous fabric. Microporous fabric is a high technology fabric combining a liquid-resistant microporous film with a fabric-like polypropylene. Alternatively, the paw cover of the present invention may be made from other non-woven materials such as polypropylene, polyethylene, non-woven polypropylene SMS (spunbond/meltblown/spunbond), or any combination of such non-woven materials.

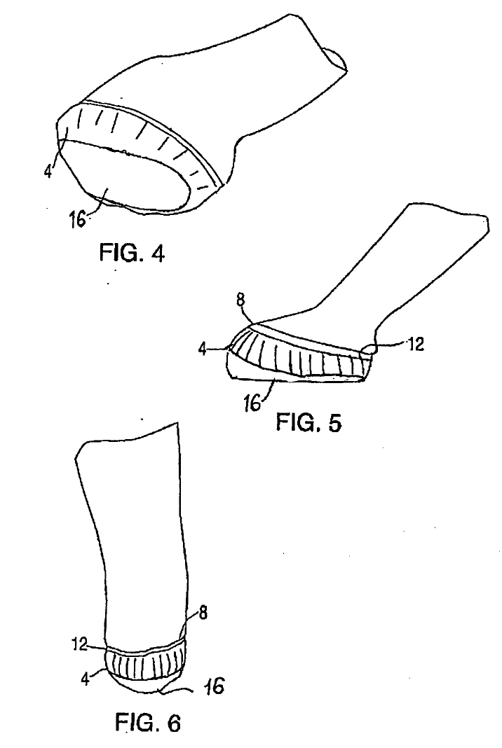

Use of the paw cover of the present invention is illustrated in FIGS. 4-6. To place the paw cover onto an animal's paw, a user will expand the elastic band 8 and insert the animal's paw into the opening 6. Because the height of the side surface 4 does not substantially exceed the height of the animal's paw, when the user releases the elastic band allowing it to contract again, the entire paw cover 10 is positioned substantially around the paw's perimeter, leaving part of the top portion of the paw exposed. Additionally, when the paw cover of the present invention is used on dog paws, because of the shape of a dog's paw, the entire paw cover appears slanted, i.e. the frontal portion of the cover is located substantially higher (extending over dog's nails) than the back portion, as shown, for example, in FIG. 5.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may also be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

I claim as follows:

1. An animal paw cover, comprising:
a side surface;
a bottom surface; and
an opening having an elastic band secured thereto,
wherein said animal paw cover is substantially sack-shaped, wherein said bottom surface of said paw cover is sized to have an area substantially equal to an area of an underside of a paw of an animal intended to wear said paw cover, wherein a height of said side surface does not substantially exceed a height of the paw of the animal intended to wear said paw cover, and wherein said elastic band constricts said opening to a size substantially smaller than the paw of the animal intended to wear said paw cover.

2. The animal paw cover according to claim 1, wherein the side surface and the bottom surface are part of a single, seamless, circular piece of material that provides the sack-shape.

3. The animal paw cover according to claim 1, further comprising a channel located along a circumference of said opening, said elastic band being inserted into said channel.

4. The animal paw cover according to claim 2, further comprising a protective cover layer secured to an outer surface of said animal paw cover.

5. The animal paw cover according to claim 4, wherein said protective cover layer is made of a vinyl material.

6. The animal paw cover according to claim 5, wherein the protective cover layer is made of polyvinylchloride.

7. The animal paw cover according to claim 4, wherein the protective cover layer is made of polylatex.

8. The animal paw cover according to claim 4, wherein said protective cover layer extends over said bottom surface of said paw cover and a frontal portion of said side surface of said paw cover.

9. The animal paw cover according to claim 4, wherein the protective cover layer is circular.

10. The animal paw cover according to claim 9, wherein the protective cover layer is off-center to the circular piece of material.

11. The animal paw cover according to claim 9, wherein the protective cover layer is centered on the circular piece of material.

12. The animal paw cover according to claim 1, wherein said animal paw cover is made from a microporous fabric.

13. The animal paw cover according to claim 1, wherein said animal paw cover is made from a non-woven material.

14. The animal paw cover according to claim 13, wherein the animal paw cover is made from a polypropylene material and/or a polyethylene material.

15. An animal paw cover, comprising:
a sack,
said sack further comprising a side surface having a height and an opening having an elastic band secured thereto,
wherein said elastic band constricts said opening to a size substantially smaller than a paw of an animal intended to wear said paw cover, and wherein said height of said side surface does not substantially exceed a height of said animal's paw such that when said animal paw cover is placed onto said animal's paw the entire animal paw cover is positioned substantially around a paw's perimeter leaving a top portion of the paw exposed.

16. The animal paw cover according to claim 15, wherein the sack is formed from a single, seamless circular piece of material.

17. The animal paw cover according to claim 15, further comprising a channel located along a circumference of said opening, said elastic band being inserted into said channel.

18. The animal paw cover according to claim 16, further comprising a protective cover layer secured to an outer surface of said animal paw cover.

19. The animal paw cover according to claim 18, wherein said protective cover layer extends over a bottom surface of said sack and a frontal portion of said side surface of said sack.

20. The animal paw cover according to claim 18, wherein the protective cover layer is circular.

21. The animal paw cover according to claim 20, wherein the protective cover layer is off-center to the circular piece of material.

22. The animal paw cover according to claim 20, wherein the protective cover layer is centered on the circular piece of material.

23. The animal paw cover according to claim 18, wherein said protective cover layer is made of a vinyl material.

24. The animal paw cover according to claim 23, wherein the protective cover layer is made of polyvinylchloride.

25. The animal paw cover according to claim 18, wherein the protective cover layer is made of polylatex.

26. The animal paw cover according to claim 15, wherein said animal paw cover is made from a microporous fabric.

27. The animal paw cover according to claim 15, wherein said animal paw cover is made from non-woven material.

28. The animal paw cover according to claim 27, wherein the animal paw cover is made from a polypropylene material and/or a polyethylene material.
